(19) United States
(12) Patent Application Publication
(10) Pub. No.: US 2017/0154480 A1
(43) Pub. Date: Jun. 1, 2017

(54) INFORMATION PROCESSING APPARATUS AND LARGE SCALE INTEGRATED CIRCUIT

(71) Applicant: Renesas Electronics Corporation, Tokyo (JP)

(72) Inventor: Hiromichi TAKAHASHI, Tokyo (JP)

(21) Appl. No.: 15/361,306

(22) Filed: Nov. 25, 2016

(30) Foreign Application Priority Data
Dec. 1, 2015 (JP) 2015-234507

(51) Int. Cl. G07C 5/08; B60R 16/023; B60W 30/18

(52) U.S. Cl. CPC G07C 5/0808; B60W 30/18054; B60R 16/0231

(57) ABSTRACT

In a failure diagnosis of a multiprocessor LSI to secure the functional safety of the LSI mounted in an automobile, an object of the present invention is to reduce overhead such as functions and programs to perform the failure diagnosis at appropriate timing at which a standard process to be executed by the LSI is not sacrificed.

A multiprocessor LSI has a normal operation mode in which a standard process is executed by operating a plurality of mounted processor cores in parallel and a failure diagnosis mode in which a failure diagnosis process is executed by some of the processor cores and the standard process is continued by the other processor cores. The normal operation mode is transited to the failure diagnosis mode when an idling stop signal in an automobile having the multiprocessor LSI mounted is asserted, and the failure diagnosis mode is returned to the normal operation mode when the idling stop signal is negated.

### CROSS-REFERENCE TO RELATED APPLICATIONS

The disclosure of Japanese Patent Application No. 2015-234507 filed on Dec. 1, 2015 including the specification, drawings and abstract is incorporated herein by reference in its entirety.

### BACKGROUND

The present invention relates to an information processing apparatus and a large scale integrated circuit (LSI), and can be preferably used for, particularly, a failure diagnosis of an information processing apparatus that is mounted in an automobile and includes a large scale integrated circuit having a plurality of processors.

In order to secure the functional safety of a semiconductor device mounted in an automobile, it is effective to perform a failure diagnosis at appropriate timing at which a standard process is not sacrificed.

Japanese Unexamined Patent Application Publication No. 2010-218277 discloses a failure diagnosis system that can identify a CPU (Central Processing Unit) core in which an abnormality occurs among a plurality of CPU cores without interfering with the execution speed of a standard process. As an example of a system to which the failure diagnosis system is applied, Japanese Unexamined Patent Application Publication No. 2010-218277 shows a multi-CPU core microcomputer configured using a CPU core 0 and a CPU core 1, and the CPU cores 0 and 1 are individually operated by an OS while being switched between an SMP mode and an AMP mode. In this case, the SMP (Symmetric Multi-Processing) mode is a processing mode in which one OS shares the CPU core 0, the CPU core 1, and a memory, and dynamically assigns a task to the CPU core with less processing load. On the other hand, the AMP (Asymmetric Multi-Processing) mode is a processing mode in which a task assigned to the CPU core is set in advance. In the multi-CPU core microcomputer to which the failure diagnosis system is applied, both of the CPU core 0 and the CPU core 1 normally execute a standard process in the SMP mode. When a failure diagnosis is performed, one CPU core is switched to the AMP mode to execute a task of the failure diagnosis, and the other CPU core continues the standard process in the SMP mode. In this case, before the CPU core executing the task of the failure diagnosis is switched from the SMP mode to the AMP mode, the OS confirms that the standard process performed only by one CPU core after confirming the processing load does not interfere with the execution speed, and thus ensures that the standard process is executed without being delayed if the failure diagnosis is performed. In order to realize this, the multi-CPU core microcomputer described in Japanese Unexamined Patent Application Publication No. 2010-218277 includes a load prediction unit that can predict a processing load in the future by observing a task queue. Further, a bus used when the standard process is performed and a bus used when the failure diagnosis is performed are separately provided.

### SUMMARY

As a result of a study of Japanese Unexamined Patent Application Publication No. 2010-218277, the inventors found the following new problem.

The inventors found that it is necessary to provide a function and a program (for example, the task queue and the load prediction unit) for predicting a processing load, resulting in overhead to ensure that the standard process can be executed without being delayed even if the failure diagnosis is performed.

Means for solving such a problem will be described below, and the other problems and novel features will become apparent from the description of the specification and the accompanying drawings.

According to an embodiment, the following is disclosed.

Namely, the present invention provides an information processing apparatus that is mounted in an automobile and includes a plurality of processors. The information processing apparatus has a normal operation mode in which a standard process is executed by operating the processors in parallel and a failure diagnosis mode in which a failure diagnosis process is executed by some of the processors and the standard process is continued by the other processors. The normal operation mode is transited to the failure diagnosis mode when an idling stop signal in the automobile is asserted, and the failure diagnosis mode is returned to the normal operation mode when the idling stop signal is negated.

The following is a summary of an effect that can be obtained in the embodiment.

Namely, it is not necessary to provide a function and a program to predict the processing loads of a plurality of processors, and it is possible to largely reduce overhead to ensure that a failure diagnosis is executed without sacrificing a standard process.

### BRIEF DESCRIPTION OF THE DRAWINGS

FIG. 1 is an explanatory diagram for schematically showing a configuration example of an information processing apparatus according to a representative embodiment;

FIG. 2 is an explanatory diagram for schematically showing an operation example of the information processing apparatus according to the representative embodiment;

FIG. 3 is a block diagram for showing a configuration example (second embodiment) of a central control system of an information processing apparatus;

FIG. 4 is a block diagram for showing a configuration example of a large scale integrated circuit (LSI) of a second embodiment;

FIG. 5 is a flowchart for showing an operation example of an information processing apparatus of the second and third embodiments;

FIG. 6 is a flowchart (first half) for showing another operation example of the information processing apparatus of the second and third embodiments;

FIG. 7 is a flowchart (second half) for showing another operation example of the information processing apparatus of the second and third embodiments;

FIG. 8 is a block diagram for showing a configuration example (third embodiment) of a distributed processing system (parallel execution) of an information processing apparatus;

FIG. 9 is a block diagram for showing a configuration example of a large scale integrated circuit (LSI) of the third embodiment;

FIG. 10 is a block diagram for showing a configuration example (fourth embodiment) of a distributed processing system (serial execution) of an information processing apparatus;

FIG. 11 is a block diagram for showing a configuration example of a large scale integrated circuit (LSI) of a fourth embodiment;

FIG. 12 is a flowchart (common flow for the LSIs of the first and other stages) for showing first and second operation examples of an information processing apparatus of the fourth embodiment;

FIG. 13 is a flowchart (flow by the LSI of the first stage) for showing the first operation example of the information processing apparatus of the fourth embodiment;

FIG. 14 is a flowchart (flow by the LSI of a stage other than the first stage) for showing the first operation example of the information processing apparatus of the fourth embodiment;

FIG. 15 is a flowchart (flow by the LSI of the first stage) for showing the second operation example of the information processing apparatus of the fourth embodiment; and

FIG. 16 is a flowchart (flow by the LSI of a stage other than the first stage) for showing the second operation example of the information processing apparatus of the fourth embodiment.

### DETAILED DESCRIPTION

Embodiments will be described in detail. It should be noted that the same signs are given to the constitutional elements having the same functions in all the drawings for explaining a mode for carrying out the invention, and the repeated explanation thereof will be omitted. In the case where a plurality of constitutional elements having the same function is included in one drawing, branch numbers are given. However, it is sufficient if the same function mentioned in the application satisfies identity in a certain level, and the same function includes various modified examples in more specific concepts. For example, if reference numeral “1” is given to a processor, the processor represented by reference numeral “1” with a branch number includes various modified examples without departing from the scope of the embodiments quoting the drawings, such as a von Neumann processor, a Harvard architecture processor, a CPU, a DSP (Digital Signal Processor), and an accelerator dedicated to a special calculation.

### First Embodiment

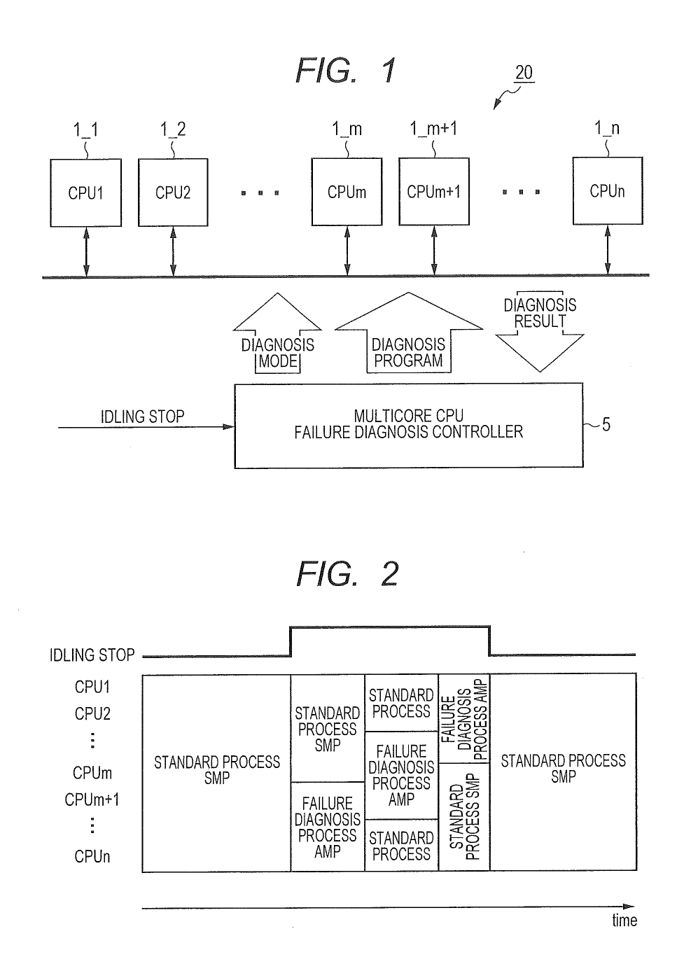

FIG. 1 is an explanatory diagram for schematically showing a configuration example of an information processing apparatus 20 according to a representative embodiment, and FIG. 2 is an explanatory diagram for schematically showing an operation example thereof.

The information processing apparatus 20 is an information processing apparatus configured using an electronic control unit (ECU) and the like mounted in an automobile, and includes a plurality of processors 1_1, 1_2, . . . , 1_m, 1m+1, . . . to 1_n.

The information processing apparatus 20 has a normal operation mode in which a standard process is executed by parallel operations of the processors 1_1, 1_2 . . . , 1_n, and a failure diagnosis mode in which a failure diagnosis process is executed by some processors (1_m+1 . . . 1_n) and the standard process is continued by other processors (1_1, 1_2, . . . 1_m). When an idling stop signal in the automobile is asserted, the information processing apparatus 20 is transited from the normal operation mode to the failure diagnosis mode. When the idling stop signal is negated, the information processing apparatus 20 is returned from the failure diagnosis mode to the normal operation mode.

As shown in FIG. 1, the plurality of the processors 1_1, 1_2, . . . , 1_n are, for example, CPU cores mounted on a plurality of LSIs configuring an ECU, and the information processing apparatus 20 includes a multicore CPU failure diagnosis controller 5. The multicore CPU failure diagnosis controller 5 supplies a diagnosis program to the plurality of the CPU cores 1_1, 1_2, . . . , 1_n or the LSIs on which the CPU cores 1_1, 1_2, . . . 1_n are mounted, and sets a diagnosis mode. Accordingly, a failure diagnosis is executed by each of the CPU cores 1_1 to 1_n, and the diagnosis results are collected.

If the LSIs configuring the ECU are multiprocessor LSIs having the CPU cores, the CPU cores mounted on the LSIs are operated in a standard mode in the normal operation mode. For example, the standard process is executed by parallel operations of the CPU cores in an SMP mode. In the failure diagnosis mode, the CPU cores are sequentially transited to the AMP mode one by one to execute the failure diagnosis process. In this case, the standard mode is an operation mode in which, for example, the standard process is executed by parallel operations of the CPU cores in the SMP mode. In the failure diagnosis mode, the CPU cores other than those executing the failure diagnosis process in the AMP mode continue the standard process in the standard mode (SMP mode). The number of CPU cores that simultaneously perform the failure diagnosis process in the failure diagnosis mode among those mounted on one LSI is not necessarily one, but each of the CPU cores may perform the failure diagnosis within a range in which the standard process can be performed without any trouble.

As shown in FIG. 2, all the CPU cores 1_1, 1_2, 1_n execute the standard process in the SMP mode in the normal operation mode in the entire information processing apparatus 20. When the idling stop signal is asserted, some CPU cores 1_m+1, . . . 1_n are transited to the AMP mode to execute the failure diagnosis process. On the other hand, other CPU cores 1_1, 1_2, . . . , 1_m continue the standard process in the SMP mode. Thereafter, when the idling stop signal is negated, all the CPU cores 1_1, 1_2, . . . 1_n are returned to the SMP mode to execute the standard process. In the period during which the idling stop signal is asserted, the CPU cores 1_1, 1_2, . . . 1_m are not fixedly kept in the SMP mode. When the failure diagnosis process of the CPU core transited to the AMP mode to perform the failure diagnosis in the same LSI is completed, the CPU cores 1_1, 1_2, . . . , 1_m are sequentially transited to the AMP mode to perform the failure diagnosis.

The idling stop signal may be detected inside the information processing apparatus 20, or may be supplied from the outside. Further, it is not necessary to provide a physical wiring, but the idling stop signal may be information representing a state in which the idling is stopped. For example, the idling stop signal may be information that is transmitted through in-vehicle CAN (Controller Area Network) or the like to be held in a register or the like.

Accordingly, in the failure diagnosis of the LSI to secure the functional safety of the multiprocessor LSI mounted in the automobile, it is possible to reduce overhead such as functions and programs to perform the failure diagnosis at appropriate timing at which the standard process to be executed by the LSI is not sacrificed. This is because a part of the processing load is transferred from the standard process to the failure diagnosis process in the idling stop state in which the processing load of the LSI can be expected to be extremely low, and thus it is not necessary to monitor or predict the processing load.

### Second Embodiment

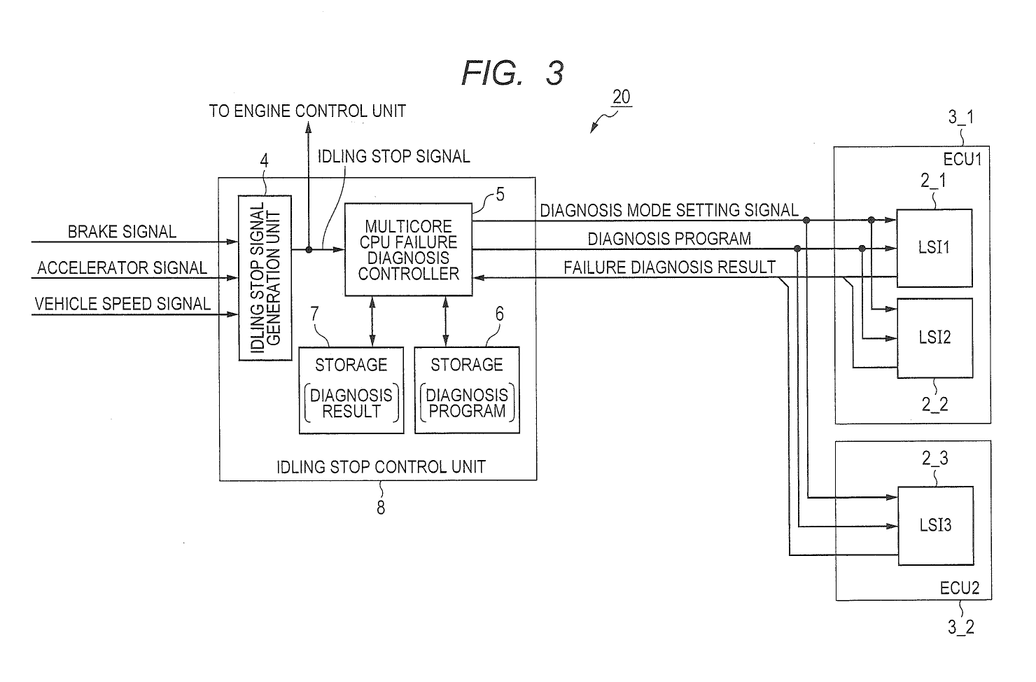

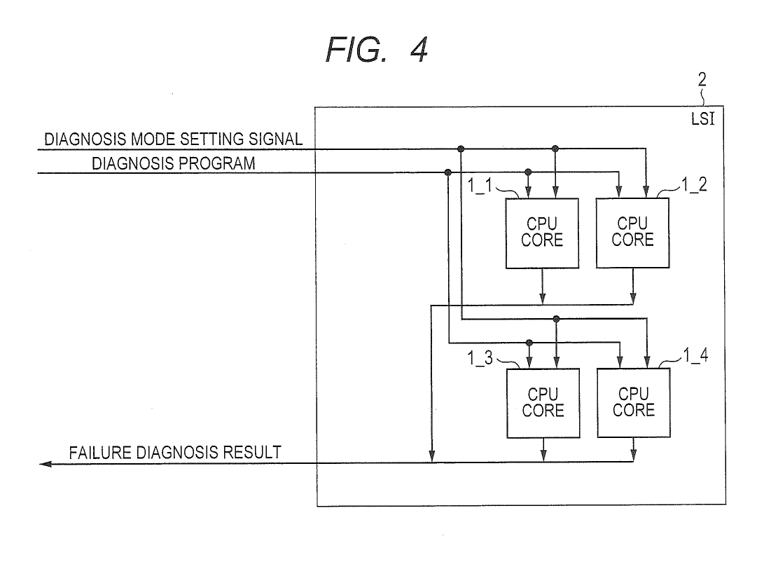

FIG. 3 is a block diagram for showing a configuration example of an information processing apparatus 20 of a central control system.

In the central control system, the information processing apparatus 20 is configured to include an idling stop control unit 8 and one or more LSIs 2_1 to 2_3 each having, at least, two processors among a plurality of processors. For example, as shown in FIG. 3, the LSI 2_1 and LSI 2_2 are mounted in an ECU 1 (3_1) and the LSI 2_3 is mounted in another ECU 2 (3_2).

The idling stop control unit 8 includes an idling stop signal generation unit 4 and a multicore CPU failure diagnosis controller 5. The idling stop signal generation unit 4 generates an idling stop signal to be supplied to the multicore CPU failure diagnosis controller 5. For example, a brake signal, an accelerator signal, and a vehicle speed signal are supplied to the idling stop signal generation unit 4. When it is determined that the idling of the engine can be stopped on the basis of these pieces of information, the idling stop signal is output to an engine control unit to stop the idling. In the embodiment, the signal is used as an activation signal for the failure detection process. The multicore CPU failure diagnosis controller 5 supplies a diagnosis program to each of the LSIs 2_1 to 2_3, and sets each of the LSIs 2_1 to 2_3 to a diagnosis mode on the basis of the idling stop signal. Accordingly, the failure diagnosis is executed, and the failure diagnosis results are collected.

The diagnosis program is stored in, for example, a diagnosis program storing storage 6 included in the idling stop control unit 8. The diagnosis program is read when the power is turned on, and is supplied to each of the LSIs 2_1 to 2_3, or supplied to each of the LSIs 2_1 to 2_3 every time the failure detection process is started. The failure diagnosis result collected from each of the LSIs 2 1 to 2 3 is stored in, for example, a diagnosis result storing storage 7 provided in the idling stop control unit 8.

When occurrence of a failure is detected, for example, a warning is given to the driver of the automobile, or is notified to a management server outside the automobile by a communication system included in the automobile.

FIG. 4 is a block diagram for showing a configuration example of an LSI 2 adopted in the central control system. The LSI 2 is a multiprocessor LSI including, for example, a plurality of CPU cores 1_1 to 1_4. The diagnosis mode is set on the basis of asserting or negating of the idling stop signal. The mode is transited from the normal operation mode to the failure diagnosis mode, or is returned from the failure diagnosis mode to the normal operation mode in accordance with the set diagnosis mode, and the failure diagnosis result in the failure diagnosis mode is output. The diagnosis program is supplied to each of the CPU cores 1_1 to 1_4 when the power is turned on, or every time the failure detection process is started. The number of CPU cores incorporated in one LSI 2 may be 2 or more. The reason is as follows: If two CPU cores are provided, the execution of the standard process can be kept by keeping one CPU core in the normal operation mode even when the other CPU core is transited to the failure diagnosis mode.

Accordingly, the failure diagnoses of all the processors (CPU cores) are controlled by the single failure diagnosis controller, and it is not necessary to provide the failure diagnosis controller in each LSI.

It is not always necessary to realize the diagnosis mode setting signal, the diagnosis program, and the failure diagnosis result shown in FIG. 3 and FIG. 4 by using dedicated physical wirings. For example, the idling stop control unit 8 and the ECU 1 (3_1) and the ECU 2 (3_2) may be coupled to each other via a communication path such as CAN, and the diagnosis mode setting information, the diagnosis program, and the failure diagnosis result may be transmitted via the communication path. In this case, the LSI 2 shown in FIG. 4 includes a communication interface such as CAN, and extracts the diagnosis mode setting information and the diagnosis program from the received signal to be set in each of the CPU cores 1_1 to 1_4. In addition, the LSI 2 places the failure diagnosis result of each of the CPU cores 1_1 to _4 on a predetermined communication packet to be transmitted from the communication interface.

Further, the diagnosis program may be stored in a storage device incorporated in each ECU or each LSI to be supplied to each CPU core, instead of being supplied from the idling stop control unit 8. For example, a non-volatile memory for the diagnosis program may be incorporated in the LSI 2 shown in FIG. 4, and the diagnosis program may be started by setting the diagnosis mode, instead of being supplied from the outside. Accordingly, a wiring between the idling stop control unit 8 and the LSI can be omitted, or communication traffic in the case where the idling stop control unit 8 and the LSI are coupled to each other via a communication path such as CAN can be reduced. Further, it is not necessary to change the content of the diagnosis program storing storage 6 in accordance with the LSI to be coupled in the idling stop control unit 8, and the ECU and the LSI that can be coupled to the idling stop control unit 8 are not restricted. Accordingly, the versatility and compatibility can be enhanced.

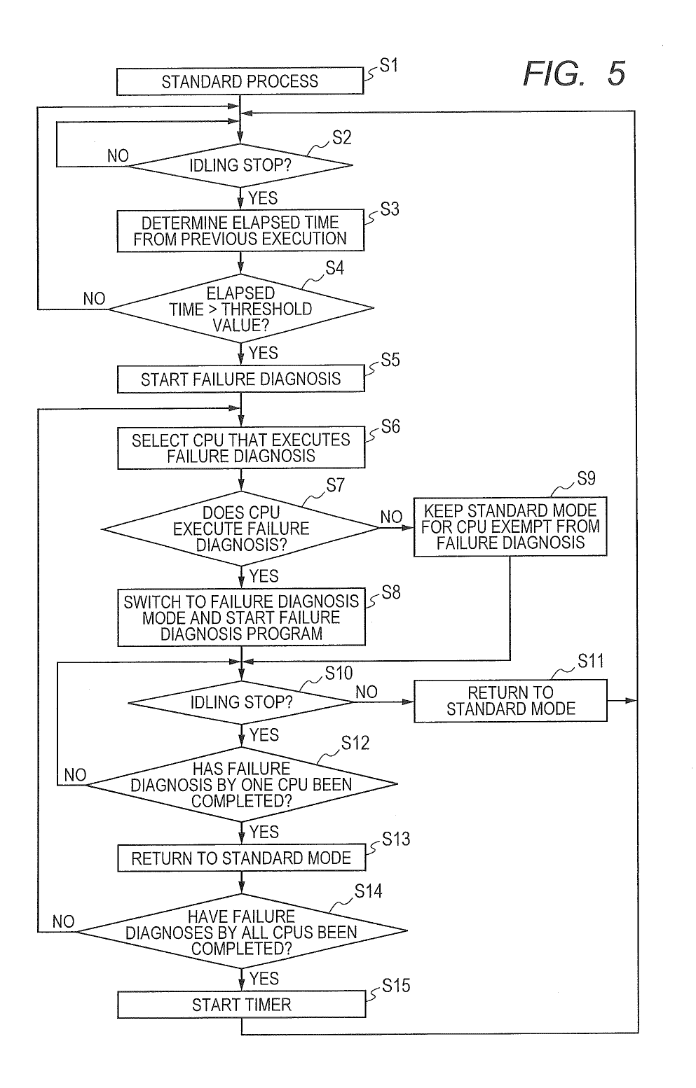

FIG. 5 is a flowchart for showing an operation example of the information processing apparatus 20 of the central control system.

It is assumed that the information processing apparatus 20 executes the standard process in the normal operation mode (S1). In this case, all the CPU cores are operated in the standard mode, and, for example, execute the standard process in parallel in the SPM mode. In the normal operation mode, the information processing apparatus 20 observes whether or not the idling stop signal has been asserted (S2). When the idling stop signal is asserted, elapsed time from the execution of the previous failure diagnosis process is determined (S3). When the elapsed time exceeds a threshold value (S4), the entire operation mode is transited to the failure diagnosis mode to start the failure diagnosis (S5). The elapsed time from the execution of the previous failure diagnosis process is counted by, for example, a timer (not shown) included in the multicore CPU failure diagnosis controller 5 (FIG. 3).

The threshold value can be arbitrarily set. For example, when the threshold value is set as 24 hours, a cycle of 24 hours or more in which the failure diagnosis is performed can be always secured. Accordingly, even when the idling stop frequently occurs, the frequency of executing the failure diagnosis is appropriately managed.

When the failure diagnosis is started (S5), the CPU core that executes the failure diagnosis process is selected (S6), and the CPU core selected for the failure diagnosis (S7) is switched to, for example, the failure diagnosis mode such as the AMP mode. Then, the failure diagnosis program is started (S8). On the other hand, the CPU core exempt from the failure diagnosis is kept in, for example, the standard mode such as the SMP mode (S9), and continuously executes the standard process.

When the idling stop signal is negated (S10), the CPU core that executes the failure diagnosis is returned to the standard mode (S11), and the flow is returned to the initial standard process (S1). On the other hand, while the idling stop signal is asserted, the failure diagnosis process is continued until the failure diagnosis of one CPU core that executes the failure diagnosis is completed (S12). When the failure diagnosis process by the CPU core is completed, the CPU core is returned to the standard mode (S13). Until the failure diagnosis processes by all the CPU cores are completed (S14), the failure diagnosis process is executed (S8) by sequentially selecting the target CPU core (S6).

When the failure diagnosis processes by all the CPU cores are completed, the timer that counts the elapsed time from the execution of the previous failure diagnosis process is reset and restarted (S15), and the flow is returned to the initial standard process (S1).

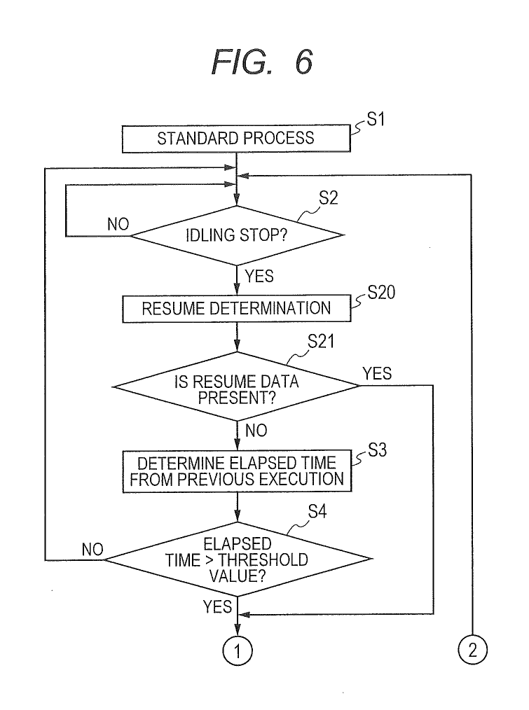

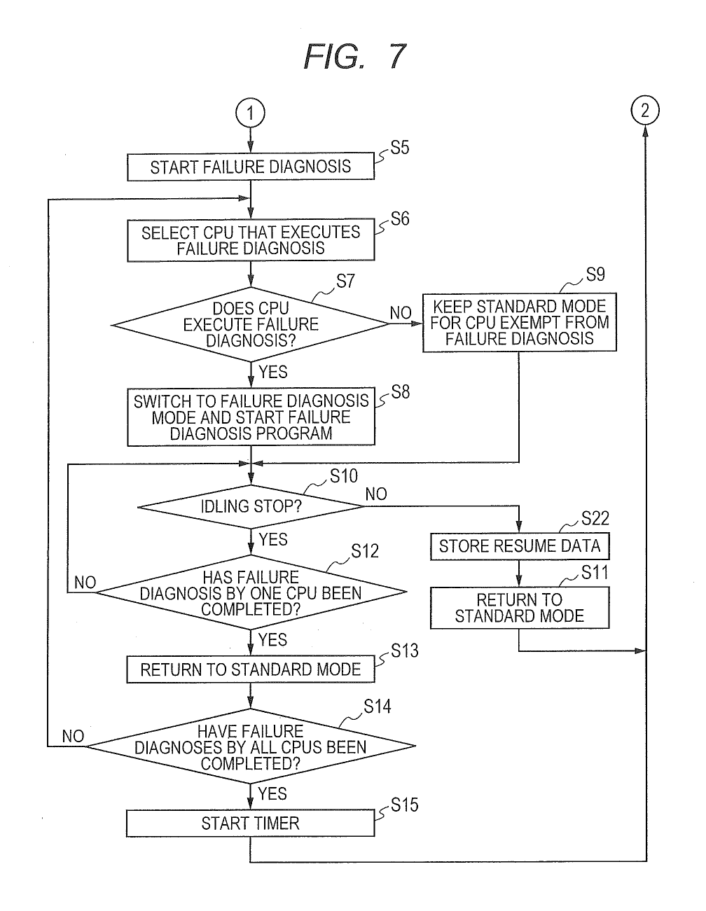

Another operation example of the information processing apparatus 20 of the central control system will be described. The operation example is an example assuming that all the failure diagnosis processes cannot be completed in one idling stop period. FIG. 6 is a flowchart of the first half of the operation example, and FIG. 7 is a flowchart of the second half.

As similar to FIG. 5, it is assumed that the information processing apparatus 20 executes the standard process in the normal operation mode (S1), and observes whether or not the idling stop signal has been asserted in the normal operation mode (S2). When the idling stop signal is asserted (S2), resume determination is performed (S20). When resume data is not present, the elapsed time from the execution of the previous failure diagnosis process is determined (S3). When the elapsed time exceeds the threshold value (S4), the failure diagnosis is started (S5). When the resume data is present, the failure diagnosis is started irrespective of the elapsed time (S5). The resume data is data representing the progress in the case where the failure diagnosis process is not completed during one idling stop period. For example, in the case where the failure diagnosis processes are sequentially performed by the CPU cores, the resume data corresponds to the number (identifier) of the last CPU core that finished the failure diagnosis process, the number (identifier) of the last diagnosis item executed among those configuring the diagnosis program, or a step number in the diagnosis program.

In the case where the resume data is present and the failure diagnosis is started (S5), the next CPU core that executes the failure diagnosis is selected on the basis of the resume data (S6). For example, in the case where the resume data represents the number (identifier) of the last CPU core that finished the failure diagnosis process, the next CPU core is selected for the failure diagnosis. For example, in the case where the resume data represents the number (identifier) of the last CPU core that executed the failure diagnosis process, the number (identifier) of the last diagnosis item executed among those configuring the diagnosis program at the time, or a step number in the diagnosis program is stored together with the same resume data, and the process may be resumed from the next diagnosis item or the next step in the diagnosis program. Alternatively, even in the case where the number (identifier) of the last diagnosis item executed or a step number in the diagnosis program is held in the resume data, the failure diagnosis may be resumed again by returning to the top of the diagnosis program by the CPU core. In the case where each step and each item in the failure diagnosis program are dependent on the history (internal state) up to the time, the failure diagnosis is resumed by returning to the top.

As shown in FIG. 7, when the failure diagnosis is started (S5), the CPU core that executes the failure diagnosis process is selected on the basis of the resume data (S6), and the CPU core selected for the failure diagnosis (S7) is switched to, for example, the failure diagnosis mode such as the AMP mode. Then, the failure diagnosis program is started (S8). On the other hand, the CPU core exempt from the failure diagnosis is kept in, for example, the standard mode such as the SMP mode (S9), and continuously executes the standard process.

When the idling stop signal is negated (S10), the progress of the failure diagnosis process at the time is stored as the resume data (S22), and the CPU core that executes the failure diagnosis is returned to the standard mode (S11). Then, the flow is returned to the initial standard process (S1).

On the other hand, while the idling stop signal is asserted, the failure diagnosis process is continued until the failure diagnosis of one CPU core that executes the failure diagnosis is completed (S12) as similar to FIG. 5. When the failure diagnosis process by the CPU core is completed, the

CPU core is returned to the standard mode (S13). Until the failure diagnosis processes by all the CPU cores are completed (S14), the failure diagnosis process is executed (S8) by sequentially selecting the target CPU core (S6). When the failure diagnosis processes by all the CPU cores are completed, the timer that counts the elapsed time from the execution of the previous failure diagnosis process is restarted (S15), and the flow is returned to the initial standard process (S1).

Accordingly, the failure diagnosis is managed so as to be equally executed by the CPU cores. For example, if a specific CPU core is fixed to execute the failure diagnosis in the beginning of each idling stop period and the order thereof is also fixed in the information processing apparatus including the CPU cores, the first CPU core for the failure diagnosis more frequently executes the failure diagnosis process than the last CPU core. In the case where a period of time of the failure diagnosis processes by all the CPU cores is longer than a standard idling stop period, there is a risk that the difference between the frequencies of executing the failure diagnosis processes largely differs depending on the CPU cores.

It should be noted that FIG. 6 and FIG. 7 show an operation example in which the elapsed time from the execution of the previous failure diagnosis process is determined (S3), and the failure diagnosis is started when the elapsed time exceeds the threshold value (S4), as similar to FIG. 5. However, S3 and S4 may be omitted. However, the frequency of executing the failure detection process can be more appropriately managed by performing the both of the resume determination (S20) and the determination of the elapsed time from the previous execution (S3) as shown in FIG. 6 and FIG. 7.

In the operation example (flowchart) shown in FIG. 5, FIG. 6, and FIG. 7, a step of outputting the failure diagnosis result is not illustrated. The failure diagnosis result may be output on a diagnosis item basis of the failure diagnosis program executed by each CPU core, or may be output every time the failure diagnosis process by each CPU core is completed. In this case, the failure diagnosis result may be used as the resume data. On the other hand, when the failure diagnosis processes by all the CPU cores are completed, the failure diagnosis results may be collectively output. Further, only when a failure occurs, the failure diagnosis result may be output.

### Third Embodiment

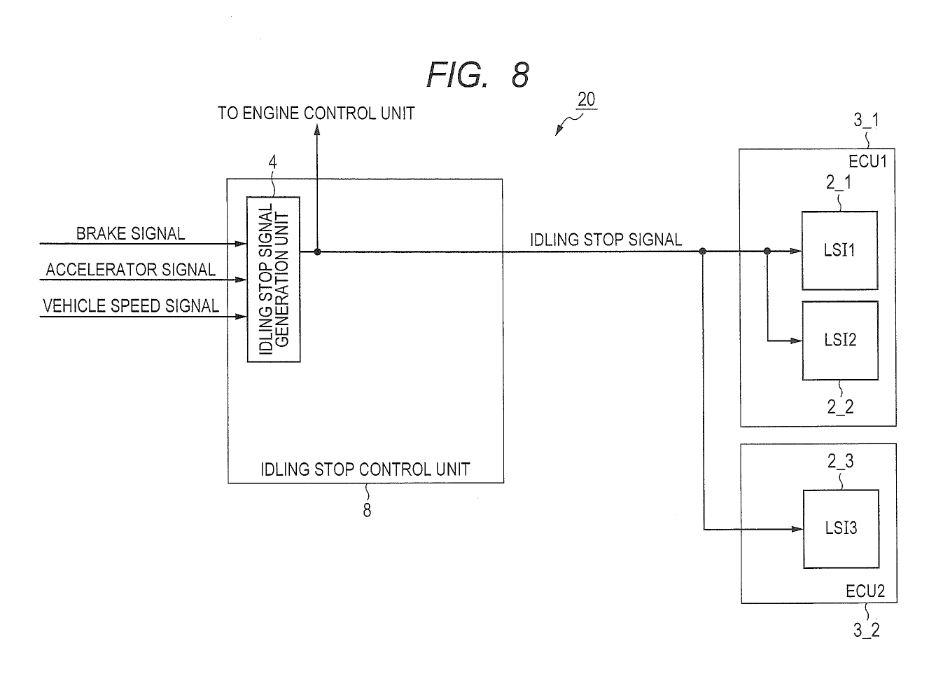

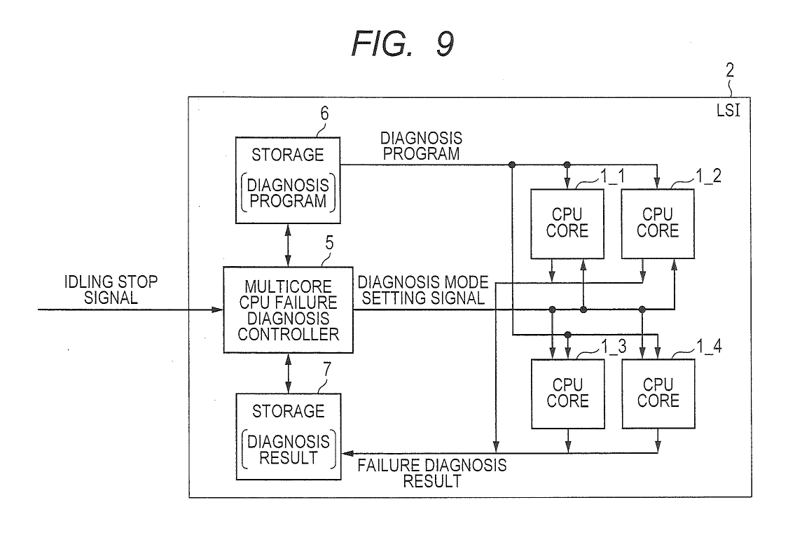

FIG. 8 is a block diagram for showing a configuration example of an information processing apparatus 20 of a distributed processing system (parallel execution). Further, FIG. 9 is a block diagram for showing a configuration example of an LSI 2 adopted in the distributed processing system (parallel execution).

In the distributed processing system (parallel execution), the information processing apparatus 20 is configured to include an idling stop control unit 8 and one or more LSIs 2_1 to 2_3 each having, at least, two processors among a plurality of processors. For example, as shown in FIG. 8, the LSI 2_1 and LSI 2_2 are mounted in an ECU 1 (3_1) and the LSI 2_3 is mounted in another ECU 2 (3_2).

The idling stop control unit 8 includes an idling stop signal generation unit 4, but does not include the multicore CPU failure diagnosis controller 5 unlike the central processing system shown in the second embodiment. The multicore CPU failure diagnosis controller 5 is incorporated in the LSI 2 as shown in FIG. 9. The same applies to the diagnosis program storing storage 6 and the diagnosis result storing storage 7. Namely, the idling stop signal is supplied to each of the LSIs 2_1 to 2_3 in parallel, and each of the LSIs 2_1 to 2_3 includes the multicore CPU failure diagnosis controller 5 to execute the failure diagnosis in parallel.

The idling stop signal generation unit 4 generates the idling stop signal to be supplied to the LSI 2_1 and LSI 2_2 of the ECU 1 (3_1) and the LSI 2_3 of the ECU 2 (3_2). The idling stop signal output from the idling stop signal generation unit 4 is a signal that is output to an engine control unit to stop the idling, and is used as an activation signal for the failure detection process in the third embodiment.

The LSI 2 adopted in the distributed processing system (parallel execution) is, for example, a multiprocessor LSI including a plurality of CPU cores 1_1 to 1_4 as shown in FIG. 9, and further includes a multicore CPU failure diagnosis controller 5, a diagnosis program storing storage 6, and a diagnosis result storing storage 7. The diagnosis program is supplied from the diagnosis program storing storage 6 to each of the CPU cores 1_1 to 1_4 when the power is turned on or every time the failure detection process is started. The multicore CPU failure diagnosis controller 5 allows each of the CPU cores 1_1 to 1_4 to execute the failure diagnosis by setting the diagnosis mode on the basis of the idling stop signal to be input, and collects the failure diagnosis results to be stored in the diagnosis program storing storage 6.

Accordingly, each of the large scale integrated circuits (LSIs) can allow the processors (CPU cores) mounted in each LSI to autonomously execute the failure diagnosis in parallel.

It is not necessary to realize the idling stop signal shown in each of FIG. 8 and FIG. 9 by using a dedicated physical wiring. For example, the idling stop control unit 8 and the ECU 1 (3_1) and ECU 2 (3_2) may be coupled to each other via a communication path such as CAN, and the idling stop information may be transmitted via the communication path. In this case, the LSI 2 shown in FIG. 9 includes a communication interface such as CAN, and extracts the idling stop information from the received signal to be supplied to the incorporated multicore CPU failure diagnosis controller 5.

The configuration example in which the diagnosis result storing storage 7 is incorporated in the LSI 2 is shown in FIG. 9. However, the configuration example may be changed so that the diagnosis result storing storage 7 is omitted, and the failure diagnosis result is output from the LSI 2 every time the diagnosis item of the failure diagnosis program is completed or the failure diagnosis of the CPU core is completed.

The operation example of the information processing apparatus 20 of the distributed processing system (parallel execution) in the third embodiment can be explained by referring to FIG. 5, FIG. 6, and FIG. 7 as similar to the second embodiment.

FIG. 5 is a flowchart for showing an operation example of the information processing apparatus 20 of the distributed processing system (parallel execution).

It is assumed that the information processing apparatus 20 executes the standard process in the normal operation mode (S1). In this case, all the CPU cores are operated in the standard mode, and, for example, execute the standard process in parallel in the SPM mode. In the normal operation mode, the information processing apparatus 20 observes whether or not the idling stop signal has been asserted (S2). When the idling stop signal is asserted, elapsed time from the execution of the previous failure diagnosis process is determined (S3). When the elapsed time exceeds a threshold value (S4), the entire operation mode is transited to the failure diagnosis mode to start the failure diagnosis (S5).

The second embodiment shows the example in which the elapsed time from the execution of the previous failure diagnosis process is counted and observed by the timer included in the multicore CPU failure diagnosis controller 5 (FIG. 3) mounted in the idling stop control unit 8. However, each of the LSIs 2_1 to 2_3 observes the elapsed time in the third embodiment. As shown in FIG. 8, since the idling stop signal is supplied to the LSIs 2_1 to 2_3 in parallel, each of the LSIs 2_1 to 2_3 includes the multicore CPU failure diagnosis controller 5 as shown in FIG. 9. The elapsed time from the execution of the previous failure diagnosis process is counted by, for example, the timer (not shown) included in the multicore CPU failure diagnosis controller 5 (FIG. 9) included in each of the LSIs 2_1 to 2_3. Further, the threshold value of the elapsed time can be. arbitrarily set for each of the LSIs 2_1 to 2_3. For example, the threshold value can be appropriately defined on the basis of a concept (policy) for securing the functional safety such as more frequently executing the failure diagnosis of the LSI mounted in the ECU that is largely affected when a failure occurs. Accordingly, even in the case where the idling stop frequently occurs, the frequency of executing the failure diagnosis is more appropriately managed.

The operations that follow are the same as those of the information processing apparatus 20 of the central control system described in the second embodiment, and thus the explanation thereof will be omitted. However, the failure diagnosis process is independently executed by each of the LSIs 2_1 to 2_3 in parallel in the information processing apparatus 20 of the distributed processing system (parallel execution).

Another operation example of the information processing apparatus 20 of the distributed processing system (parallel execution) will be described. The operation example is an example assuming that all the failure diagnosis processes in the LSI 2 cannot be completed in one idling stop period. FIG. 6 is a flowchart of the first half of the operation example, and FIG. 7 is a flowchart of the second half.

It is assumed that the information processing apparatus 20 executes the standard process in the normal operation mode (S1), and observes whether or not the idling stop signal has been asserted in the normal operation mode (S2). When the idling stop signal is asserted (S2), resume determination is performed (S20). When resume data is not present, the elapsed time from the execution of the previous failure diagnosis process is determined (S3). When the elapsed time exceeds the threshold value (S4), the failure diagnosis is started (S5). When the resume data is present, the failure diagnosis is started irrespective of the elapsed time (S5).

The resume data is data representing the progress in the case where the failure diagnosis process is not completed during one idling stop period. The resume data is held by each of the LSIs 2_1 to 2_3. For example, the resume data is stored in the diagnosis result storing storage 7 shown in FIG. 9, and is used by being read from the multicore CPU failure diagnosis controller 5. A concrete executing mode that can be adopted in the resume data is the same as the second embodiment. Further, the operations that follow are the same as those of the information processing apparatus 20 of the central control system described in the second embodiment, and thus the explanation thereof will be omitted.

As similar to the second embodiment, the output of the failure diagnosis result that is not illustrated in FIG. 5, FIG. 6, and FIG. 7 may be performed for each diagnosis item of the failure diagnosis program executed by each CPU core, or may be performed every time the failure diagnosis process by each CPU core is completed in the third embodiment. In this case, the failure diagnosis result may be used as the resume data. On the other hand, when the failure diagnosis processes by all the CPU cores are completed, the failure diagnosis results may be collectively output. Further, only when a failure occurs, the failure diagnosis result may be output.

Accordingly, the failure diagnosis is managed so as to be equally executed by the CPU cores mounted in the LSI 2.

It should be noted that as similar to FIG. 5, the operation example in which the elapsed time from the execution of the previous failure diagnosis process is determined (S3), and the failure diagnosis is started when the elapsed time exceeds the threshold value is shown in FIG. 6 and FIG. 7. However, S3 and S4 may be omitted. This point is the same as the second embodiment. However, the frequency of executing the failure detection process can be equalized in each LSI irrespective of the number of CPU cores to be mounted by performing the both of the resume determination (S20) and the determination of the elapsed time from the previous execution (S3), and accordingly the frequency of executing the failure detection process can be more appropriately managed. In the case of the LSI having the small number of CPU cores mounted, the failure diagnoses by all the CPU cores can be completed even in a relatively-short idling stop period. Thus, when such a short idling stop occurs several times, the failure diagnoses are performed the same number of times. On the other hand, in the case of the LSI having the large number of CPU cores mounted in which the failure diagnoses by all the CPU cores cannot be completed in such a short idling stop period and the resume process needs to be performed, even when the idling stop occurs the same number of times, only one failure diagnosis can be executed through plural times. Therefore, the frequency of executing the failure detection process can be equalized in each LSI irrespective of the number of CPU cores to be mounted by combining the determination of executing the failure diagnosis on the basis of the elapsed time from the execution of the previous failure diagnosis process. Fourth Embodiment

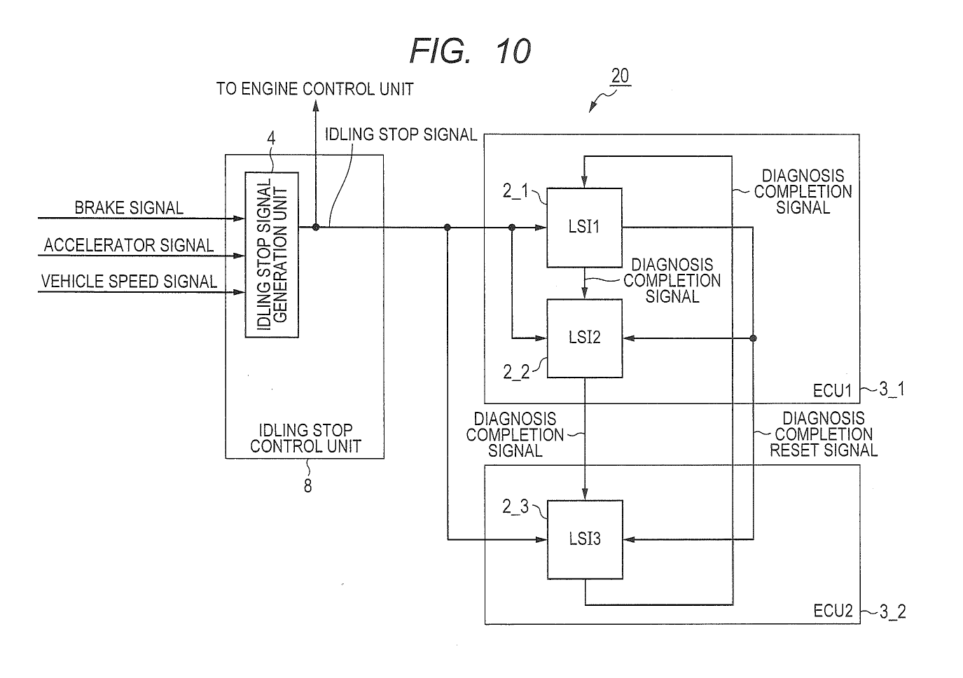

FIG. 10 is a block diagram for showing a configuration example of an information processing apparatus 20 of a distributed processing system (serial execution).

As similar to the case of the distributed processing system (parallel execution) shown in FIG. 8, the information processing apparatus 20 of the distributed processing system (serial execution) is also configured to include an idling stop control unit 8 and one or more LSIs 2_1 to 2_3 each having, at least, two processors among a plurality of processors. Shown is an example in which the LSI 2_1 and the LSI 2_2 are mounted in an ECU 1(3_1), and the LSI 2_3 is mounted in another ECU 2 (3_2).

The idling stop control unit 8 includes an idling stop signal generation unit 4. However, unlike the central processing system shown in the second embodiment, the idling stop control unit 8 does not include the multicore CPU failure diagnosis controller 5, and the idling stop signal is generated to be supplied to each of the LSIs 2_1 to 2_3. This configuration is the same as that of the distributed processing system (parallel execution) shown in FIG. 8.

Each of the LSIs 2_1 to 2_3 sequentially supplies a ring-like diagnosis completion signal representing the completion of the failure diagnosis of itself to the LSI of the next stage. It is assumed that the LSI 2_1 is an LSI of the first stage that executes the failure diagnosis first when the idling stop signal is asserted. When the failure diagnosis of the LSI 2_1 is completed, the diagnosis completion signal for the LSI 2_2 is asserted. Thereafter, the completion of the failure diagnosis of itself is sequentially transmitted to the LSI of the next stage by asserting the diagnosis completion signal. Finally, the diagnosis completion signal is fed back from the LSI 2_3 of the last stage to the LSI 2_1 of the first stage. Further, it is more preferable if a diagnosis completion reset signal is supplied from the LSI 2_1 of the first stage to the other LSIs 2_2 to 2_3. When the ring-like diagnosis completion signal is returned to the LSI 2_1 of the first stage, it is possible to detect the completion of one cycle of the failure diagnosis process. Thus, the state of the completion of one cycle of the failure diagnosis process is reset at this time, and it is possible to prepare for the start of the next failure diagnosis process.

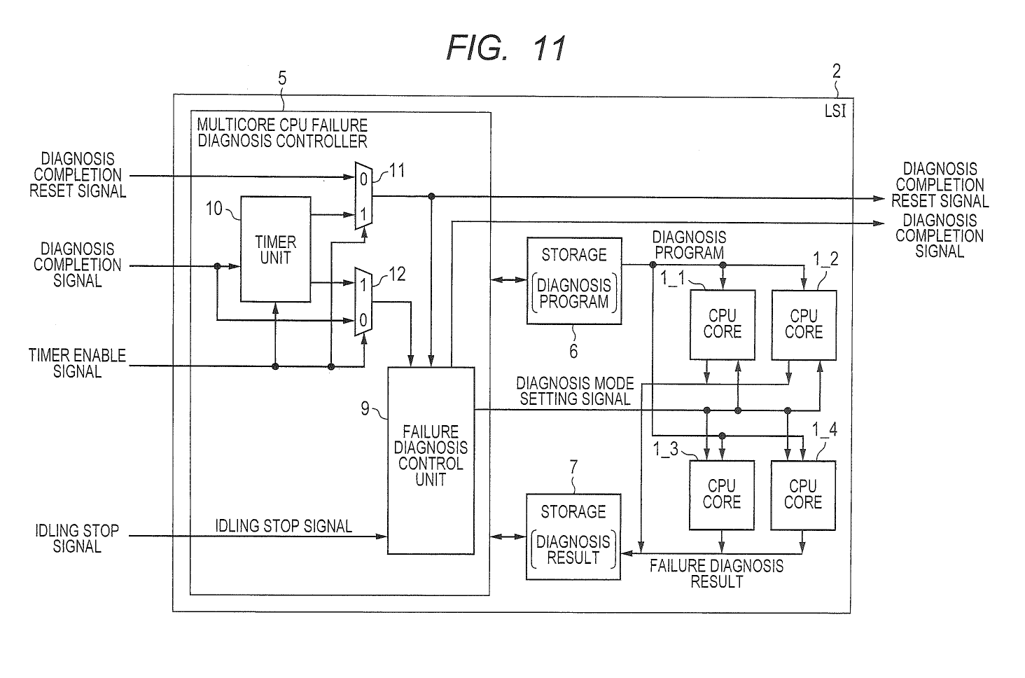

FIG. 11 is a block diagram for showing a configuration example of the LSI 2 adopted in the distributed processing system (serial execution). The LSI 2 is, for example, a multiprocessor LSI including a plurality of CPU cores 1_1 to 1_4, and further includes a multicore CPU failure diagnosis controller 5, a diagnosis program storing storage 6, and a diagnosis result storing storage 7. This point is the same as the LSI 2 adopted in the distributed processing system (parallel execution) shown in FIG. 9, but is different in that the multicore CPU failure diagnosis controller 5 includes a failure diagnosis control unit 9, a timer unit 10, and two selectors 11 and 12, and receives the diagnosis completion signal from the previous stage to be output to the next stage. Further, the diagnosis completion reset signal is input or output. In the case of the configuration shown in FIG. 10, when the LSI 2 is operated as the first stage, the diagnosis completion reset signal is output. When the LSI 2 is operated as a stage other than the first stage, the diagnosis completion reset signal is input. On the other hand, as similar to the diagnosis completion signal, the diagnosis completion reset signal maybe configured in a ring shape, so that the input diagnosis completion reset signal is sequentially supplied to the LSI of the next stage in the entire information processing apparatus 20 by configuring the LSIs 2 as shown in FIG. 11.

In addition, a timer enable signal for controlling whether or not to use the timer unit 10 is input. When the LSI 2 is operated as the first stage, the timer enable signal is set as “1”, and the timer unit 10 is set to be operated. When the timer enable signal is “1” (the LSI 2 is operated as the first stage), the selector 11 selects the output of the timer unit 10. When the timer enable signal is “0” (the LSI 2 is operated as a stage other than the first stage), the selector 11 selects the input diagnosis completion reset signal to be output to the next stage as the diagnosis completion reset signal. When the timer enable signal is “1” (the LSI 2 is operated as the first stage), the selector 12 selects the output of the timer unit 10. When the timer enable signal is “0” (the LSI 2 is operated as a stage other than the first stage), the selector 12 selects the input diagnosis completion signal to be supplied to the failure diagnosis control unit 9.

In the case where the LSI 2 is operated as the first stage, the failure diagnosis control unit 9 allows the CPU cores 1_1 to 1_4 to start the failure diagnosis processes on the basis of the output of the timer unit 10 and the idling stop signal, and outputs the diagnosis completion signal to the next stage when all the failure diagnosis processes are completed. In the case where the LSI 2 is operated as a stage other than the first stage, the failure diagnosis control unit 9 allows the CPU cores 1_1 to 1_4 to start the failure diagnosis processes on the basis of the diagnosis completion signal input from the previous stage instead of the output of the timer unit 10 and the idling stop signal, and outputs the diagnosis completion signal to the next stage when all the failure diagnosis processes are completed. In the case where the LSI 2 is operated as the first stage, the diagnosis completion signal to be output is reset by the output of the timer unit 10 supplied from the selector 11. In the case where the LSI 2 is operated as a stage other than the first stage, the diagnosis completion signal to be output is reset by the diagnosis completion reset signal input from the previous stage.

In the case where the information processing apparatus 20 is configured as shown in FIG. 10, the diagnosis completion reset signal need not be input to the LSI 2 operated as the first stage, and the output of the timer unit 10 is used as the diagnosis completion reset signal. In the LSI 2 operated as a stage other than the first stage, the diagnosis completion signal output from the failure diagnosis control unit 9 is reset by the input diagnosis completion reset signal.

The other configurations of the CPU cores 1_1 to 1_4, the diagnosis program storing storage 6, and the diagnosis result storing storage 7 are the same as those of the distributed processing system (third embodiment) of the parallel execution shown in FIG. 9, and thus the explanation thereof will be omitted.

Next, an operation example of the information processing apparatus 20 will be described.

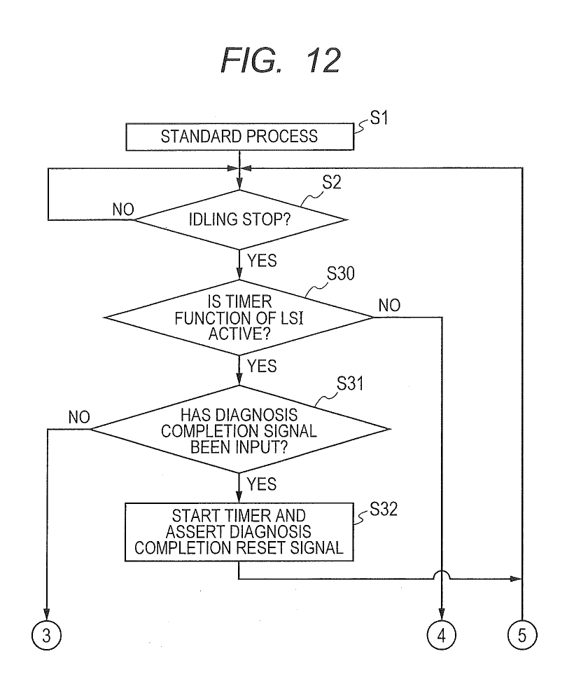

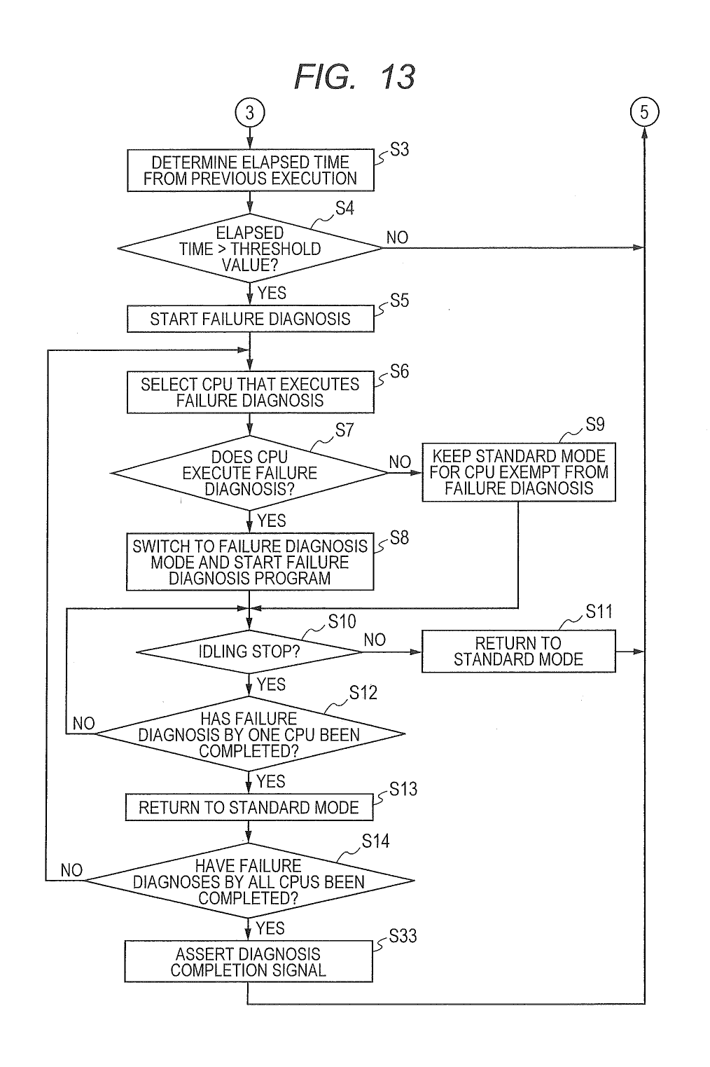

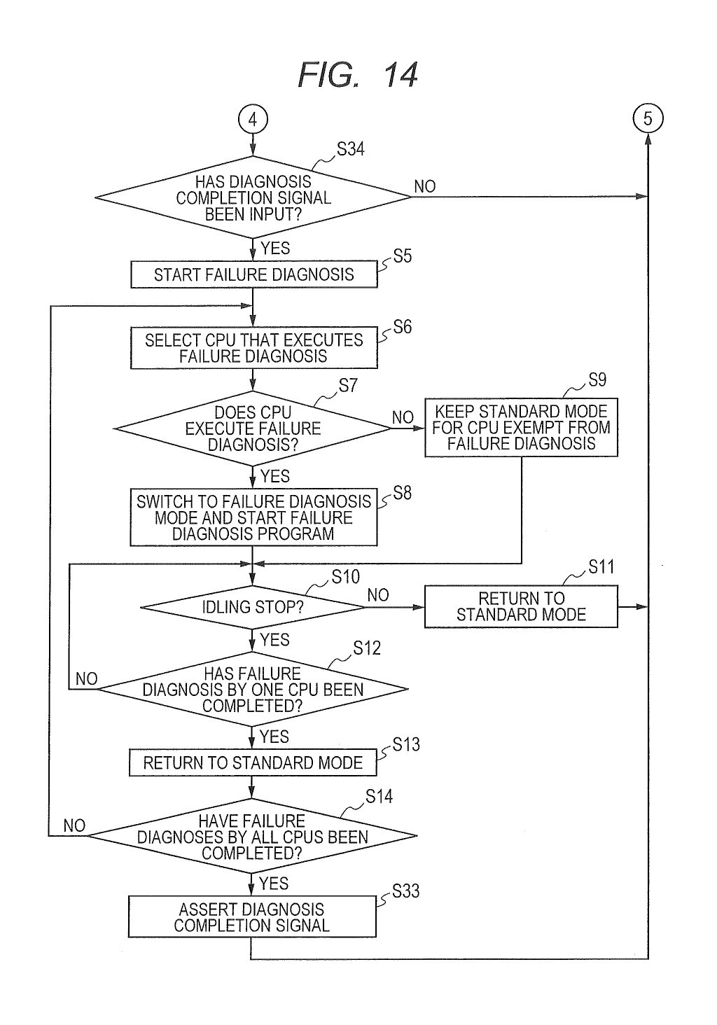

FIG. 12, FIG. 13, and FIG. 14 are flowcharts for showing a first operation example of the information processing apparatus 20 of the distributed processing system (serial execution). FIG. 13 shows a flow by the LSI 2 of the first stage, FIG. 14 shows a flow by the LSI 2 of a stage other than the first stage, and FIG. 12 shows a common flow for both.

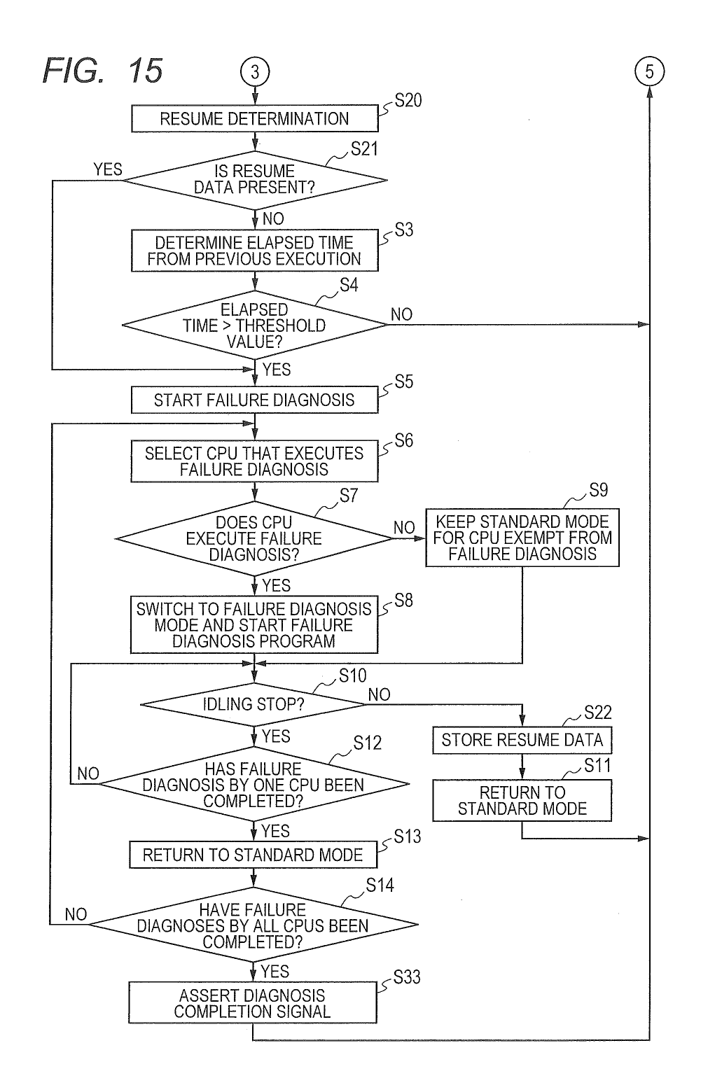

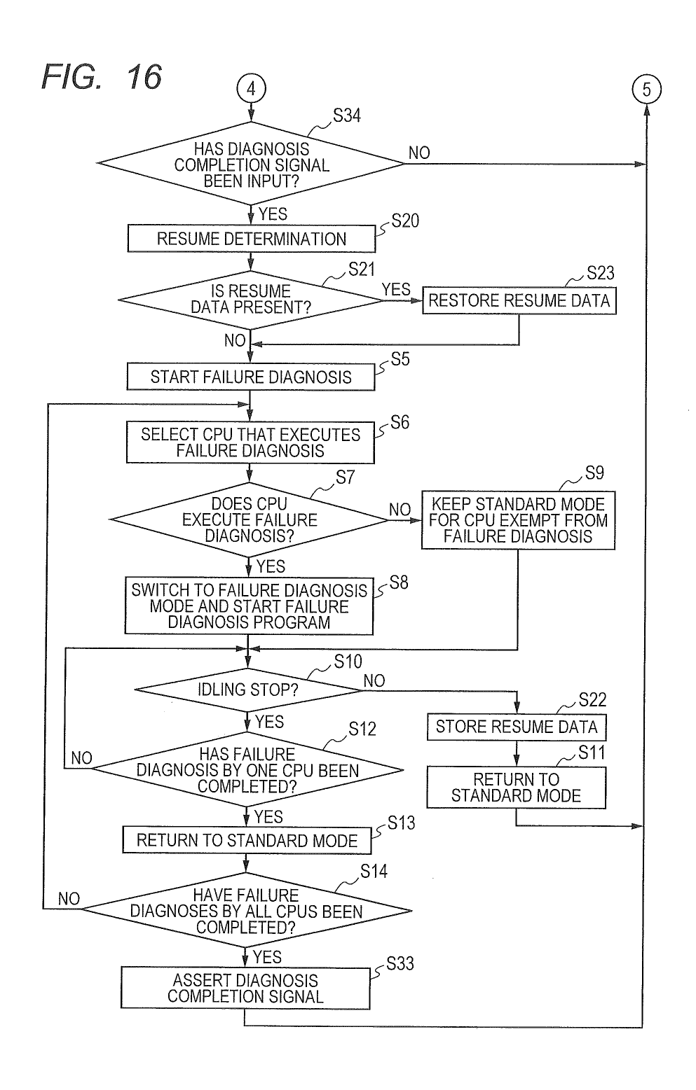

FIG. 12, FIG. 15, and FIG. 16 are flowcharts for showing a second operation example of the information processing apparatus 20 of the distributed processing system (serial execution). FIG. 15 shows a flow by the LSI 2 of the first stage, FIG. 16 shows a flow by the LSI 2 of a stage other than the first stage, and FIG. 12 shows a common flow for both.

The first operation example is an operation in which the resume process is not included as described by referring to FIG. 5, and the second operation example is an operation in which the resume process is included as described by referring to FIG. 6 and FIG. 7.

First, the operation in which the resume process is not included will be described.

As shown in FIG. 12, the information processing apparatus 20 executes the standard process in the normal operation mode (S1), and observes whether or not the idling stop signal has been asserted (S2). When the idling stop signal is asserted, it is determined whether or not the LSI has an active timer function (S30). In the example of FIG. 11, it is determined whether or not to use the timer unit 10 on the basis of the timer enable signal, namely, whether the LSI 2 is of the first stage or of a stage other than the first stage. In the case where the timer function is active, namely, the LSI 2 is of the first stage, it is observed whether or not the diagnosis completion signal from the previous stage has been input (S31). When the diagnosis completion signal from the previous stage is input, the timer is reset to restart, and the diagnosis completion reset signal is asserted (S32). This is a case in which the diagnosis completion signal is input from the LSI of the last stage to the LSI of the first stage in the LSIs configured in a ring shape, and means that the failure diagnosis process of the entire information processing apparatus 20 has been completed. Thus, the timer is reset to restart at this time. When the next idling stop signal is asserted, the elapsed time from the execution of the previous failure diagnosis can be obtained by the timer. In the case where the LSI 2 is of the first stage, the flow proceeds to FIG. 13. In the case where the LSI 2 is of a stage other than the first stage, the flow proceeds to FIG. 14.

In the case where the LSI 2 is of the first stage (FIG. 13), the timer function is active, and the elapsed time from the execution of the previous failure diagnosis is measured by the timer unit 10. First, the elapsed time from the previous execution is determined (S3). When the elapsed time exceeds the threshold value (S4), the entire operation mode is transited to the failure diagnosis mode to start the failure diagnosis (S5).

When the failure diagnosis is started (S5), the CPU core that executes the failure diagnosis process is selected (S6), and the CPU core selected for the failure diagnosis (S7) is switched to, for example, the failure diagnosis mode such as the AMP mode. Then, the failure diagnosis program is started (S8). On the other hand, the CPU core exempt from the failure diagnosis is kept in, for example, the standard mode such as the SMP mode (S9), and continuously executes the standard process.

When the idling stop signal is negated (S10), the CPU core that executes the failure diagnosis is returned to the standard mode (S11), and the flow is returned to the initial standard process (S1 of FIG. 12). On the other hand, while the idling stop signal is asserted, the failure diagnosis process is continued until the failure diagnosis of one CPU core that executes the failure diagnosis is completed (S12). When the failure diagnosis process by the CPU core is completed, the CPU core is returned to the standard mode (S13). Until the failure diagnosis processes by all the CPU cores are completed (S14), the failure diagnosis process is executed (S8) by sequentially selecting the target CPU core (S6).

When the failure diagnosis processes by all the CPU cores are completed, the diagnosis completion signal is asserted (S33), and the flow is returned to the initial standard process (S1 of FIG. 12). The diagnosis completion signal is transmitted to the LSI of the next stage to start the failure diagnosis process.

In the case where the LSI 2 is of a stage other than the first stage (FIG. 14), the timer function is inactive, and the elapsed time from the execution of the previous failure diagnosis is not observed. It is determined whether or not the diagnosis completion signal has been input from the LSI of the previous stage (S34). When the diagnosis completion signal is input, the failure diagnosis process is started (S5).

The flow after the failure diagnosis process is started (S5) is the same as the case in which the LSI 2 is of the first stage as shown in FIG. 13, and thus the explanation thereof will be omitted.

Next, the operation in which the resume process is included will be described.

The information processing apparatus 20 executes the standard process in the normal operation mode (S1). As similar to the flow shown in FIG. 12, the flow is branched into the case (FIG. 15) in which the LSI 2 is of the first stage and the case (FIG. 16) in which the LSI 2 is of a stage other than the first stage.

In the case where the LSI 2 is of the first stage (FIG. 15), the resume determination (S20 and S21) is performed first. When the resume data is not present, the elapsed time from the execution of the previous failure diagnosis process is determined (S3). When the elapsed time exceeds the threshold value (S4), the failure diagnosis is started (S5) When the resume data is present, the failure diagnosis is started irrespective of the elapsed time (S5). In the case where the LSI 2 is of the first stage, the timer function is active, and the elapsed time from the execution of the previous failure diagnosis is counted by the timer unit 10. Thus, the failure diagnosis process is started (S5) after the elapsed time exceeds the predetermined threshold value.

The resume data is data representing the progress in the case where the failure diagnosis process is not completed during one idling stop period. The resume data is held by each of the LSIs 2_1 to 2_3. For example, the resume data is stored in the diagnosis result storing storage 7 shown in FIG. 11, and is used by being read from the multicore CPU failure diagnosis controller 5. A concrete executing mode that can be adopted in the resume data is the same as the second or third embodiment.

In the case where the resume data is present and the failure diagnosis is started (S5), the next CPU core that executes the failure diagnosis is selected on the basis of the resume data (S6). The CPU core selected for the failure diagnosis (S7) is switched to, for example, the failure diagnosis mode such as the AMP mode. Then, the failure diagnosis program is started (S8). On the other hand, the CPU core exempt from the failure diagnosis is kept in, for example, the standard mode such as the SMP mode (S9), and continuously executes the standard process.

When the idling stop signal is negated (S10), the progress of the failure diagnosis process at the time is stored as the resume data (S22), and the CPU core that executes the failure diagnosis is returned to the standard mode (S11) Then, the flow is returned to the initial standard process (S1 of FIG. 12).

On the other hand, while the idling stop signal is asserted, the failure diagnosis process is continued until the failure diagnosis of one CPU core that executes the failure diagnosis is completed (S12), as similar to FIG. 13. When the failure diagnosis process by the CPU core is completed, the CPU core is returned to the standard mode (S13). Until the failure diagnosis processes by all the CPU cores are completed (S14), the failure diagnosis process is executed (S8) by sequentially selecting the target CPU core (S6). When the failure diagnosis processes by all the CPU cores are completed, the diagnosis completion signal is asserted (S33), and the flow is returned to the initial standard process (S1 of FIG. 12). The diagnosis completion signal is transmitted to the LSI of the next stage to start the failure diagnosis process.

In the case where the LSI 2 is of a stage other than the first stage (FIG. 16), it is first determined whether or not the diagnosis completion signal from the LSI of the previous stage has been input (S34). In the case where the diagnosis completion signal from the LSI of the previous stage has not been input, the flow is returned to the initial standard process (S1). The idling stop signal is asserted, the elapsed time from the previous execution exceeds the threshold value, and any one of the LSIs in the information processing apparatus 20 executes the failure diagnosis process. However, the LSI waits for the input of the diagnosis completion signal from the previous stage while being not executing the failure diagnosis process, or has already asserted the diagnosis completion signal to the next state after completion of the failure diagnosis. Thus, the LSI is executing the standard process.

When the diagnosis completion signal from the LSI of the previous stage is input, the resume determination (S20 and S21) is performed. In the case where the resume data is not present, the failure diagnosis is started (S5). However, in the case where the resume data is present, the failure diagnosis is started (S5) after the resume data is restored (S23).

In the case where the resume data is present and the failure diagnosis is started (S5), the next CPU core that executes the failure diagnosis is selected on the basis. of the restored resume data (S6). The concrete mode of the resume data is the same as that described in the second embodiment. The restoring is not necessary in some cases depending on the concrete mode of the resume data.

The flow after the failure diagnosis process is started (S5) is the same as the case in which the LSI 2 is of the first stage as shown in FIG. 15, and thus the explanation thereof will be omitted.

In the case where the LSI 2 is of the first stage as shown in FIG. 15, the timer function is activated to determine the elapsed time from the execution of the previous failure diagnosis process (S3). When the elapsed time exceeds the threshold value (S4) and the LSI 2 is of a stage other than the first stage as shown in FIG. 16, the failure diagnosis is started irrespective of the elapsed time (S5). The elapsed time from the execution of the previous failure diagnosis only needs to be managed at one section of the information processing apparatus 20. Thus, the fourth embodiment is an embodiment in which the elapsed time is managed by the LSI of the first stage.

The threshold value of the elapsed time from the execution of the previous failure diagnosis process after activating the timer function may be independently set to each LSI of a stage other than the first stage. In this case, in the case where the diagnosis completion signal is input from the previous stage and the elapsed time does not exceed the predetermined threshold value, the execution of the failure diagnosis process in the LSI is omitted, and the diagnosis completion signal is output to the next stage. Accordingly, even if the LSI that need not frequently execute the failure diagnosis exists in the ring configured in the information processing apparatus 20, it is possible to minimize the time required for the entire failure diagnosis process.

The second, third, and fourth embodiments and the modified embodiments described above that are different from each other may be mixed and implemented in one information processing apparatus.

The invention achieved by the inventors has been described above in detail on the basis of the embodiments. However, it is obvious that the present invention is not limited to the embodiments, but can be variously changed without departing from the scope of the invention.

For example, the division of the functional blocks in the illustrated block diagram is merely an example, and can be variously changed without departing from the scope thereof. The storages 6 and 7 may be mounted as one physical memory element. On the contrary, the storages 6 and 7 may be mounted in such a manner that the functions thereof are distributed to a plurality of memory elements, or may be external ones without being incorporated into the LSI 2. In addition, the signal definition in which the timer function is activated when the timer enable signal is “1” and the timer function is inactivated when the timer enable signal is “0” is merely an example, and can be variously changed without departing from the scope thereof.

What is claimed is:

1. An information processing apparatus that is mounted in an automobile and comprises a plurality of processors,
wherein the processors have a normal operation mode in which a standard process is executed by parallel operations and a failure diagnosis mode in which a failure diagnosis process is executed by some of the processors and the standard process is continued by the other processors, and
wherein the normal operation mode is transited to the failure diagnosis mode when an idling stop signal in the automobile is asserted, and the failure diagnosis mode is returned to the normal operation mode when the idling stop signal is negated.

2. The information processing apparatus according to claim 1,
wherein an idling stop control unit and a large scale integrated circuit having, at least, two processors among the processors are provided, wherein the idling stop control unit includes an idling stop signal generation unit and a failure diagnosis controller,
wherein the idling stop signal generation unit generates the idling stop signal to be supplied to the failure diagnosis controller, and
wherein the failure diagnosis controller supplies a diagnosis program to the large scale integrated circuit, and sets the large scale integrated circuit to the diagnosis mode on the basis of the idling stop signal, so that the failure diagnosis is executed by the large scale integrated circuit to collect a failure diagnosis result from the large scale integrated circuit.

3. The information processing apparatus according to claim 2,
wherein the failure diagnosis controller can count elapsed time from the previous execution of the failure diagnosis, and
wherein in the case where the idling stop signal is asserted and the elapsed time exceeds a predetermined threshold value, the next failure diagnosis is executed by the large scale integrated circuit.

4. The information processing apparatus according to claim 3,
wherein in the case where the idling stop signal is negated before completion of the failure diagnosis, the failure diagnosis controller allows the large scale integrated circuit to store progress data of the failure diagnosis, and
wherein in the case where the progress data has already been stored when the idling stop signal is asserted, the failure diagnosis controller allows the large scale integrated circuit to resume the failure diagnosis from a state on the basis of the progress data.

5. The information processing apparatus according to claim 1,
wherein an idling stop control unit and a plurality of large scale integrated circuits each having, at least, two processors among the processors are provided,
wherein the idling stop control unit generates the idling stop signal to be supplied to the large scale integrated circuits,
wherein each of the large scale integrated circuits has a failure diagnosis controller, and
wherein the failure diagnosis controller supplies a diagnosis program to each of the processors mounted in the large scale integrated circuits, and sets the processors to the diagnosis mode on the basis of the idling stop signal, so that the failure diagnoses are executed by the processors to collect failure diagnosis results from the processors.

6. The information processing apparatus according to claim 5,
wherein the failure diagnosis controller can count elapsed time from the previous execution of the failure diagnosis, and
wherein in the case where the idling stop signal is asserted and the elapsed time exceeds a predetermined threshold value, the next failure diagnosis is executed.

7. The information processing apparatus according to claim 6,
wherein in the case where the idling stop signal is negated before completion of the failure diagnosis, the failure diagnosis controller stores progress data of the failure diagnosis, and
wherein in the case where the progress data has already been stored when the idling stop signal is asserted, the failure diagnosis controller resumes the failure diagnosis from a state on the basis of the progress data.

8. The information processing apparatus according to claim 1,
wherein an idling stop control unit and a plurality of large scale integrated circuits each having, at least, two processors among the processors are provided,
wherein the idling stop control unit generates the idling stop signal to be supplied to the large scale integrated circuits in parallel,
wherein a diagnosis completion signal is sequentially supplied from a first large scale integrated circuit to the large scale integrated circuit of the next stage among the large scale integrated circuits, and the diagnosis completion signal is supplied from the large scale integrated circuit of the last stage to the first large scale integrated circuit,
wherein each of the large scale integrated circuits has a failure diagnosis controller, and
wherein the failure diagnosis controller supplies a diagnosis program to each of the processors mounted in the large scale integrated circuits, and sets the processors to the diagnosis mode on the basis of the diagnosis completion signal supplied from the large scale integrated circuit of the previous stage and the idling stop signal, so that the failure diagnoses are executed by the processors to collect failure diagnosis results from the processors, and the diagnosis completion signal is output to the large scale integrated circuit of the next stage when the failure diagnoses by all the processors mounted in the large scale integrated circuits are completed.

9. The information processing apparatus according to claim 8,
wherein the failure diagnosis controller mounted in the first large scale integrated circuit can count elapsed time from the previous execution of the failure diagnosis, and
wherein in the case where the idling stop signal is asserted and the elapsed time exceeds a predetermined threshold value, the next failure diagnosis is executed by the first large scale integrated circuit.

10. The information processing apparatus according to claim 9,
wherein in the case where the idling stop signal is negated before completion of the failure diagnosis, the failure diagnosis controller stores progress data of the failure diagnosis, and
wherein in the case where the progress data has already been stored when the idling stop signal is asserted, the failure diagnosis controller resumes the failure diagnosis from a state on the basis of the progress data.

11. A large scale integrated circuit that is mounted in an automobile and comprises a plurality of processors,
wherein the processors have a normal operation mode in which a standard process is executed by parallel operations and a failure diagnosis mode in which a failure diagnosis process is executed by one of the processors and the standard process is continued by the other processors, and
wherein the normal operation mode is transited to the failure diagnosis mode when an idling stop signal in the automobile is asserted, and the failure diagnosis mode is returned to the normal operation mode when the idling stop signal is negated.

12. The large scale integrated circuit according to claim 11,
wherein the diagnosis mode is set on the basis of the asserting or negating of the idling stop signal, and
wherein the normal operation mode is transited to the failure diagnosis mode and the failure diagnosis mode is returned to the normal operation mode in accordance with the set diagnosis mode, and a diagnosis result in the failure diagnosis mode is output.

13. The large scale integrated circuit according to claim 12,
wherein the progress of the failure diagnosis process is held when being instructed to return from the failure diagnosis mode to the normal operation mode by the setting of the diagnosis mode during the execution of the failure diagnosis process, and the failure diagnosis process is resumed on the basis of the held progress when being instructed to transit from the normal operation mode to the failure diagnosis mode next time.

14. The large scale integrated circuit according to claim 11,
wherein the idling stop signal is input from the outside,
wherein a failure diagnosis controller is further provided, and
wherein the failure diagnosis controller supplies a diagnosis program to each of the processors, and sets the diagnosis mode on the basis of the idling stop signal, so that the failure diagnoses are sequentially executed by the processors to collect failure diagnosis results from the processors.

15. The large scale integrated circuit according to claim 14,
wherein the failure diagnosis controller can count elapsed time from the previous execution of the failure diagnosis, and
wherein in the case where the idling stop signal is asserted and the elapsed time exceeds a predetermined threshold value, the next failure diagnosis is executed.

16. The large scale integrated circuit according to claim 15,
wherein in the case where the idling stop signal is negated before completion of the failure diagnosis, the failure diagnosis controller stores progress data of the failure diagnosis, and
wherein in the case where the progress data has already been stored when the idling stop signal is asserted, the failure diagnosis controller resumes the failure diagnosis from a state on the basis of the progress data.

17. The large scale integrated circuit according to claim 11,
wherein the idling stop signal and a previous-stage diagnosis completion signal are input from the outside,
wherein a failure diagnosis controller is further provided to output a diagnosis completion signal, and
wherein the failure diagnosis controller supplies a diagnosis program to each of the processors, and the diagnosis mode is set on the basis of the previous-stage diagnosis completion signal and the idling stop signal, so that the failure diagnoses are sequentially executed by the processors to collect failure diagnosis results from the processors, and the diagnosis completion signal is asserted when the failure diagnoses by all the processors are completed.

18. The large scale integrated circuit according to claim 17,
wherein timer enable information can be set,
wherein the failure diagnosis controller can count elapsed time from the previous execution of the failure diagnosis,
wherein the idling stop signal is asserted when the timer enable information is asserted, and the diagnosis mode is set when the elapsed time exceeds a predetermined threshold value, and
wherein the idling stop signal is asserted when the timer enable information is negated, and the diagnosis mode is set when the previous-stage diagnosis completion signal is asserted.

19. The large scale integrated circuit according to claim 18,
wherein in the case where the idling stop signal is negated before completion of the failure diagnosis, the failure diagnosis controller stores progress data of the failure diagnosis, and
wherein in the case where the progress data has already been stored when the idling stop signal is asserted, the failure diagnosis controller resumes the failure diagnosis from a state on the basis of the progress data.
